(19) United States
(12) Patent Application Publication
(10) Pub. No.: US 2015/0245024 A1
(43) Pub. Date: Aug. 27, 2015

(54) METHOD AND APPARATUS FOR DEBLOCKING-FILTERING SECOND IMAGE FROM ENCODING INFORMATION ON FIRST IMAGE IN STEREOSCOPIC VIDEO

(71) Applicant: SK TELECOM CO., LTD., Seoul (KR)

(72) Inventors: Seung-ho SHIN, Incheon (KR); Ki-mun KIM, Seongnam-si (KR)

(21) Appl. No.: 14/697,554

(22) Filed: Apr. 27, 2015

Related U.S. Application Data
(63) Continuation of application No. PCT/KR2013/009557, filed on Oct. 25, 2013.

(30) Foreign Application Priority Data
Oct. 25, 2012 (KR) 10-2012-0119260

(51) Int. Cl. H04N 19/117; H04N 19/80; H04N 19/167; H04N 19/176; H04N 19/182

(52) U.S. Cl. CPC H04N 19/117; H04N 19/176; H04N 19/182; H04N 19/167; H04N 19/80

(57) ABSTRACT

An apparatus for deblocking-filtering a secondary image from encoding information on a primary image in a stereoscopic video, includes a block mode determiner to determine, from a bitstream, a block mode of a current block of the primary image and a block mode of a neighboring block of the current block; a boundary conditions determiner to determine a boundary condition for the current block and the neighboring block from the bitstream; a filtering strength determiner to determine a filtering strength according to at least one of the block mode of the current block of the primary image, the block mode of the neighboring block and the boundary condition; and a filtering unit to filter boundary pixels adjacent to a boundary between a current block of the secondary image and a neighboring block thereof according to the filtering strength.

### CROSS-REFERENCE TO RELATED APPLICATIONS

The present application is a continuation of International Patent Application No. PCT/KR2013/009557, filed on Oct. 25, 2013, which is based upon and claims the benefit of priority to Korean Patent Application No. 10-2012-0119260, filed on Oct. 25, 2012. The disclosure of the above-listed applications are hereby incorporated by reference herein in their entirety.

### TECHNICAL FIELD

The present disclosure in one or more embodiments relates to a method and apparatus for deblocking-filtering a secondary image from encoding information on a primary image in stereoscopic video.

### BACKGROUND

The statements in this section merely provide background information related to the present disclosure and do not necessarily constitute prior art.

Existing deblocking filtering techniques apply to all of the 4×4 block boundary edges in a frame. The techniques, whose performances are macroblock-based, utilize the pixel values on the left and upper sides of the current macroblock, and process the luminance and chrominance components separately. Filtering is performed first on the vertical boundary, and is further performed on horizontal edges from top to bottom. In general, filtering of luminance components is performed on four 16-pixel edges and filtering of chrominance components is performed on two 8-pixel edges.

The inventor(s) has noted that those deblocking filtering techniques is able to increase the compression efficiency by significantly improving the subjective quality of the video. However, the inventor(s) has experienced that with inherently high complexity in implementation, the known deblocking filtering process imposes a bottleneck on video compression. The inventor(s) has also experienced that for the known deblocking filtering techniques, increasing the image resolution only aggravates the difficulty of real-time image processing and they are virtually incompetent in some higher speed operation for simultaneous processing of the left and right images as in the stereoscopic video. The inventor(s) has noted that for this reason, deblocking operations are often deliberately dispensed with, resulting in critical degradation of image quality over time.

The inventor(s) has noted that in theory, having left and right image pairs for constituting each frame, stereoscopic video requires a data amount and coding operation quantity twice those of the corresponding 2D video. The inventor(s) has experienced that to transmit stereoscopic video images in a low-performance/low-band video transmission environment such as, for example, mobile phones, there is a need for an efficient coding method that is able to prevent deterioration of image quality while reducing implementation complexity.

### SUMMARY

In accordance with some embodiments of the present disclosure, an apparatus for deblocking-filtering a secondary image from encoding information on a primary image in a stereoscopic video comprises: an encoding information acquition unit, a block mode determiner, boundary conditions determiner, a filtering strength determiner and a filtering unit. The encoding information acquition unit is configured to acquire encoding information on a current block of the primary image and a neighboring block of the current block from a bitstream. The block mode determiner is configured to determine, from the bitstream, a block mode pair composed of a block mode of the current block of the primary image and a block mode of the neighboring block of the current block. The boundary conditions determiner is configured to determine a boundary condition for the current block and the neighboring block from the encoding information. The filtering strength determiner is configured to determine a filtering strength according to the block mode pair and the boundary condition. The filtering unit is configured to filter boundary pixels adjacent to a boundary between a current block of the secondary image and a neighboring block thereof according to the filtering strength.

In accordance with another embodiment of the present disclosure, a method performed by an apparatus for deblocking-filtering a secondary image from encoding information on a primary image in a stereoscopic video, includes: determining, from a bitstream, a block mode of a current block of the primary image and a block mode of a neighboring block of the current block; determining a boundary condition for the current block and the neighboring block from the bitstream; determining a filtering strength according to at least one of the block mode of the current block of the primary image, the block mode of the neighboring block and the boundary condition; and filtering boundary pixels adjacent to a boundary between a current block of the secondary image and a neighboring block thereof according to the filtering strength.

### BRIEF DESCRIPTION OF DRAWINGS

FIG. 1 is a schematic block diagram of a deblocking filtering apparatus according to at least one embodiment of the present disclosure.

FIG. 2 is a diagram of various exemplary block mode pairs of current blocks and neighboring blocks according to at least one embodiment of the present disclosure.

FIG. 3 is a diagram of exemplary deblocking filtering of a current block according to at least one embodiment of the present disclosure.

FIG. 4 is a flowchart of a method for deblocking filtering according to at least one embodiment of the present disclosure.

### DETAILED DESCRIPTION

Hereinafter, at least one embodiment of the present disclosure will be described in detail with reference to the accompanying drawings. In the following description, like reference numerals designate like elements, although the elements are shown in different drawings. Further, in the following description of the at least one embodiment, a detailed description of known functions and configurations incorporated herein will be omitted for the purpose of clarity and for brevity.

Some embodiments of the present disclosure provide effective removal of blocking artifacts from stereoscopic video images in a low-performance/low-band video transmission environment. In addition, some embodiments of the present disclosure provide enhancement of the filtering speed through reduction of implementation complexity and load of operation and to preserve a subjective/objective image quality equivalent to or higher than existing methods by applying different filtering techniques to a left-view image and a right-view image based the properties of human vision according to temporal/spatial complexities.

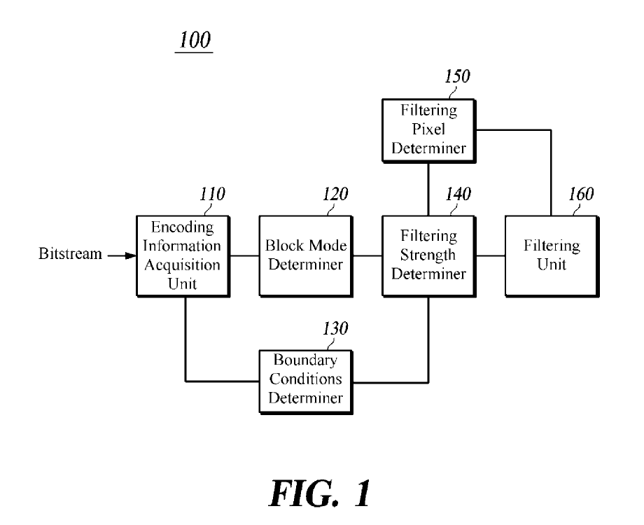

FIG. 1 is a schematic block diagram of a deblocking filtering apparatus according to at least one embodiment of the present disclosure.

According to this embodiment, a deblocking filtering apparatus 100 includes an encoding information acquisition unit 110, a block mode determiner 120, a boundary conditions determiner 130, a filtering strength determiner 140, a filtering pixel determiner 150 and a filtering unit 160. Those skilled in the art will appreciate that the components of the deblocking filtering apparatus 100 depicted by the encoding information acquisition unit 110, block mode determiner 120, boundary conditions determiner 130, filtering strength determiner 140, filtering pixel determiner 150 and filtering unit 160 are illustrative only and are subject to various modifications, additions and substitutions without departing from the characteristics of the disclosure. Other components of the deblocking filtering apparatus 100, such as each of the encoding information acquisition unit 110, the block mode determiner 120, the boundary conditions determiner 130, the filtering strength determiner 140, the filtering pixel determiner 150 and the filtering unit 160 is implemented by, or includes, one or more processors and/or application-specific integrated circuits (ASICs). The deblocking filtering apparatus 100 further comprises input units (not shown in FIG. 1) such as one or more buttons, a touch screen, a mic and so on, and output units (not shown in FIG. 1) such as a display, an indicator and so on.

The deblocking filtering apparatus 100 is an apparatus for deblocking-filtering a secondary image from encoding information on a primary image in a stereoscopic video. Hereinafter, description will be given on an assumption that the primary image is a left-view image, and the secondary image is a right-view image.

An encoding entity (e.g., an encoding apparatus of a broadcast station) for generating stereoscopic images encodes and transmits a stereoscopic image in the form of a bitstream, and a decoding apparatus of a receive entity having received the transmitted bitstream via a wireless/wired medium decodes a left-view image and a right-view image from the bitstream to output an image.

The decoding apparatus reconstructs residual block(s) by performing dequantization or inverse transform of the bitstream received from the decoding apparatus, and generates a predicted block by acquiring information on prediction from the bitstream. Thereafter, the decoding apparatus reconstructs an original block by combining the residual block(s) and the predicted block. Then, deblocking filtering is performed to remove many blocking artifacts contained in the reconstructed original block. Herein, the stereoscopic image includes a left-view image and a right-view image. Accordingly, the encoded bitstream includes encoding information on the left-view image and encoding information on the right-view image, and the decoding apparatus decodes the left-view image and the right-view image respectively from the transmitted bitstream.

Meanwhile, filtering is performed through three steps which include a boundary strength determination, a filter decision and a filter implementation.

Herein, the boundary strength determination is a process of determining filtering strength, and the filter decision is for determining boundary sampling by investigating neighboring pixels. Final pixel values without the blocking artifacts that distort the blocks are output via the step of filtering implementation.

Filtering of the left-view image is performed in step with a known process, whereas filtering of the right-view image is performed in the process described below. Herein, the known process adopted to filter the left-view image refers to a process of determining deblocking parameters such as boundary strength according to various conditions relating to, for example, whether a coding mode of the current block and the neighboring blocks uses intra prediction, whether the boundary is a macroblock boundary, and whether transform coefficients are given to perform filtering. Since such existing deblocking filtering techniques are well known, a detailed description thereof will be skipped.

The encoding information acquisition unit 110 acquires encoding information on the current block and neighboring blocks of the left-view image from the bitstream. Herein, the current block of the left-view image refers to a block of the left-view image which is at the same location as that of the current block of the right-view image to be decoded in the time domain. Accordingly, unless described otherwise, the current block of the left-view image will refer to a block at the same location as that of the current block of the right-view image to be decoded in the time domain.

Data transmitted over a bitstream includes encoding information of a left-view image constituting a stereoscopic image and encoding information on a right-view image constituting the stereoscopic image. Since deblocking filtering occurs between the current block and the left block and between the current block and the upper block, the encoding information acquired from the encoding information acquisition unit 110 includes the sizes and locations of the left neighboring image and the upper neighboring block adjacent to the current block of the left-view image.

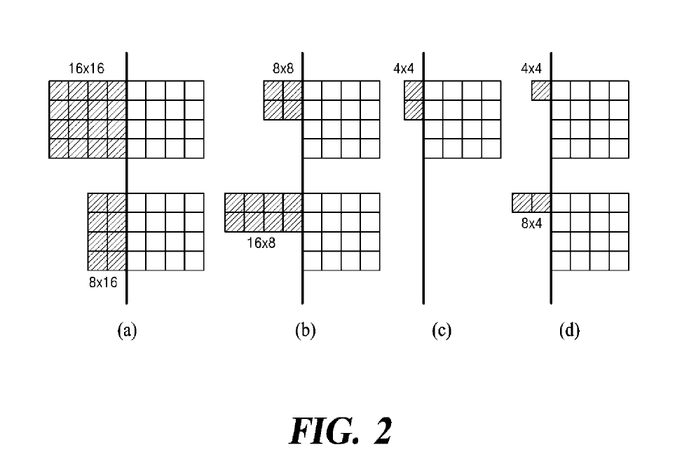

FIG. 2 is a diagram of various exemplary block mode pairs of current blocks and neighboring blocks. FIG. 2 shows various examples according to changes in the size of a neighboring block of the left-view image when 16×16 mode is the block mode of the current block of the left-view image. In FIG. 2, one small square represents size 4×4.

The block mode determiner 120 determines a block mode pair representing a block mode of the current block and a block mode of a neighboring block in the left-view image from the acquired encoding information. Herein, the block mode refers to a block unit to be decoded. For example, the block modes include various modes such as 16×16, 16×8, 8×16, 8×8, 8×4, 4×8, and 4×4. In addition, the neighboring block refers to a block arranged in a direction of deblocking filtering. Accordingly, the neighboring block is the left image or upper image of the current block.

The boundary conditions determiner 130 determines boundary conditions of the current block and neighboring block of the left-view image from the encoding information. In other words, the boundary conditions determiner 130 determines the number of pixels in a boundary region in which the current block and the neighboring block of the left-view image are adjacent to each other.

The filtering strength determiner 140 determines filtering strength for the right-view image according to the block mode pair and boundary conditions of the left-view image.

Table 1 below shows exemplary filtering strength according to the block mode pair and boundary conditions. In Table 1, p denotes a neighboring block of the current block of the left-view image, and q denotes the current block of the left-view image.

In Table 1, boundaries between blocks are divided into four types of Flat, Simple, Normal and Complex based on the type of the neighboring block and the properties of human vision, and different filtering strengths are assigned to the respective boundary types.

As shown in Table 1, as complexity between the current block (q) of the left-view image and the neighboring block (p) thereof increases, the value of filtering strength for the right-view image increases.

TABLE 1

| p, q Intra Coding Relation | Filter Mode | Region |
|---|---|---|
| p and q are MB mode and boundary is | 4 | Flat |
| a 16-pixel boundary | | |
| p and q are MB mode and boundary is | 3 | Simple |
| an 8-pixel boundary | | |
| p and/or q is sub-MB mode and boundary is | 7 | Normal |
| an 8-pixel boundary | | |
| p and/or q is sub-MB mode and boundary is | | |
| a 4-pixel boundary | 1 | Complex |
| Otherwise | 0 (no filtering) | — |

As shown in Table 1, the filtering strength varies depending on the length of the boundary between the current block of the left-view image and the neighboring block thereof and the block mode representing the block size.

In addition, if the length of the boundary between the current block of the left-view image and a neighboring block thereof is equal to the length of one side of the maximum block, the filtering strength for the right-view image is maximized. If the length of the boundary between the current block of the left-view image and a neighboring block thereof is equal to the length of one side of the minimum block, the filtering strength for the right-view image is minimized. If the length of the boundary between the current block of the left-view image and a neighboring block thereof is between the length of one side of the minimum block and the length of one side of the maximum block, the filtering strength for the right-view image changes according to the length of the boundary and a block mode representing a block size.

For example, in Table 1, if the block modes of p and q are both a macroblock (MB) mode, and the number of pixels of a boundary region (a boundary condition) is 16 (i.e., the length of one side of the maximum block), then the filtering strength (filter mode) is 4 (the maximum filtering strength). Herein, the MB mode represents one of block modes 16×16, 16×8, 8×16 and 8×8. In other words, the MB mode indicates that the size of a block is greater than or equal to a predetermined size.

FIG. 2(a) illustrates an example of filtering strength set to 4. In this example, the block modes of p and q are both MB mode, and the number of neighboring boundary pixels is 16.

FIG. 2(b) illustrates an example of filtering strength set to 3. In this example, the block modes of p and q are both MB mode, and the number of pixels on the boundary is 8 as shown in Table 1.

FIG. 2(c) illustrates an example of filtering strength set to 2. In this example, at least one of the two blocks is not the MB mode, and the number of pixels on the block boundary is 8 as shown in Table 1.

FIG. 2(d) illustrates an example of filtering strength set to 1. In this example, at least one of the two blocks is not the MB mode, and the number of pixels on the block boundary is 4 as shown in Table 1.

The examples shown in FIG. 2 are only a few of possible cases, the block mode of the current block of the left-view image has various sizes other than 16×16.

Further, as shown in Table 1 and FIG. 2, as the size of the current block of the left-view image or a neighboring block thereof increases, the value of filtering strength increases. Regarding the complexity of an image, human vision is inherently more sensitive to block discontinuity of flat and simple regions than to a complex region. This means that the complexity of an image decreases as the size of a coding block increases, according to the properties of human vision. Accordingly, as many discontinuities as possible are removed by increasing the filtering strength. If the size of a coding block is small, this means a high complexity of the image, and thus filtering is performed by lowering the filtering strength to remove a small number of discontinuities.

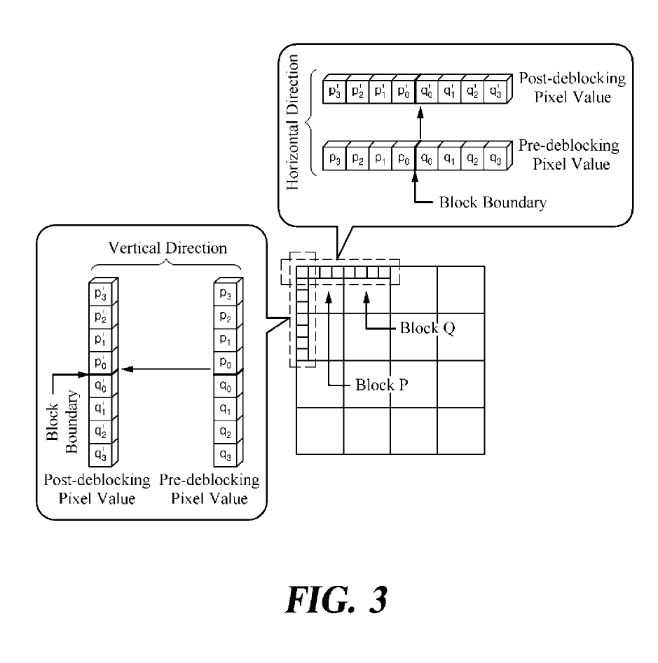

FIG. 3 is a diagram of exemplary deblocking filtering of a current block.

The filtering pixel determiner 150 determines the number of input pixels participating in filtering and the number of boundary pixels to be filtered, according to the determined filtering strength. Herein, the number of input pixels participating in filtering refers to the number of pixels used for filtering. For example, when filtering is performed in the vertical direction in FIG. 3, the number of input pixels is the number of taps for a finite impulse response filter (FIR filter) used to perform deblocking on q0. For example, when a 4-tap FIR filter is used, q0, p0, p1 and q1 are used to generate q0′, which is an outcome of deblocking filtering of q0.

The number of boundary pixels to be filtered indicates the number of pixels of a block to be filtered, which are counted from the pixel at the boundary. Specifically, in FIG. 3, the number of boundary pixels indicates whether only p0 and q0 are filtered or p0, p1, q0 and q1 are filtered.

According to some embodiments, the filtering pixel determiner 150 determines the number of input pixels participating in filtering according to the filtering strength with the number of boundary pixels to be filtered determined, or determines the number of boundary pixels to be filtered according to the filtering strength with the number of input pixels participating in filtering determined.

If the filtering pixel determiner 150 is not used, filtering is performed by the filtering unit 160, which will be described later, using a predetermined number of boundary pixels to be filtered and a predetermined number of input pixels participating in filtering.

The filtering unit 160 filters boundary pixels adjacent to a boundary between the current block of a right-view image and a neighboring block of the right-view image. As mentioned above, the filtering unit 160 performs deblocking filtering using the number of boundary pixels to be filtered and the number of input pixels participating in filtering which are predetermined or determined according to the filtering strength.

As such, decoding of the left-view image is completed by reconstructing a residual signal of the left-view image from a bitstream transmitted from the encoding apparatus, generating a pre-filtered image by adding a predicted block and performing filtering on the pre-filtered image. After the pre-filtered image is reconstructed, deblocking filtering is performed on the right-view image using the encoding information (which is also referred to as decoding information since decoding is performed using the encoding information) of the left-view image. Thereby, reconstruction of the left-view image and right-view image to be decoded is completed. When reconstruction of the left-view image and right-view image is completed, a stereoscopic image is reconstructed and displayed by visually synthesizing the two images.

As described above, if deblocking filtering is performed on the pre-filtered image of the left-view image, various conditions need to be acquired from the encoding information, relating to whether the prediction is intra prediction of the current block of the left-view image and the neighboring block, whether the boundary is a macroblock boundary or a boundary of transformation, and whether transform coefficients are given, which take a lot of time to perform computation. On the other hand, if deblocking filtering is performed on the right-view image, it only needs to determine the block sizes and locations of the current block of the left-view image and neighboring blocks thereof corresponding to the location of a block participating in deblocking-filtering the right-view image, and therefore time taken to compute the filtering strength is greatly reduced.

In this way, the deblocking filtering method for the left-view image is separated from the deblocking filtering method for the right-view image. Specifically, the existing deblocking filtering method is used for the left-view image to secure as high a subjective image quality of the image as possible. For the right-view image, a filtering mode is determined by dividing each variable block into a simple region and a complex region. Then, strong filtering is applied to the simple region exhibiting little movement to reduce as many block distortions as possible, weak filtering is applied to the complex region exhibiting lots of movement to protect the edge of the actual object to additionally improve the subjective image quality of the image.

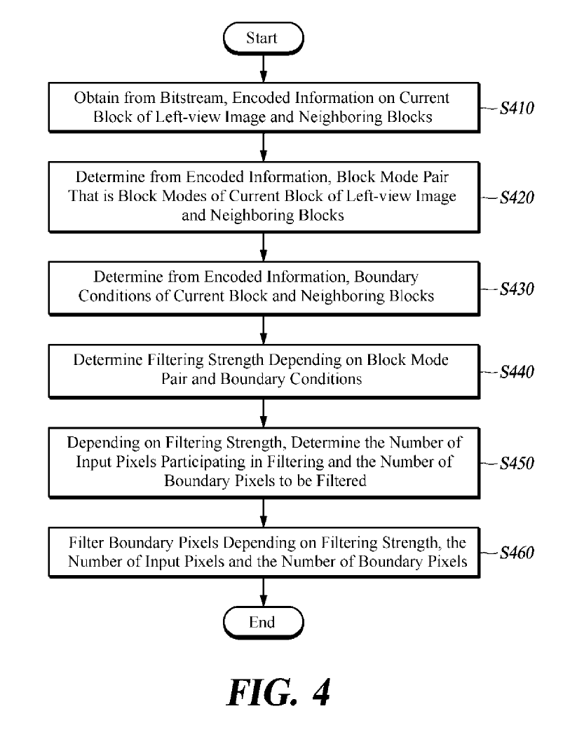

FIG. 4 is a flowchart of a method for deblocking filtering according to at least one embodiment.

As shown in FIG. 4, the method for deblocking filtering includes acquiring, from a bitstream, encoding information on a current block of the left-view image and a neighboring block thereof (Step S410), determining, from the encoding information, a block mode pair composed of the block mode of the current block of the left-view image and the block mode of the neighboring block (S420), determining the boundary conditions for the current block and the neighboring block from the encoding information (S430), determining a filtering strength according to the block mode pair and the boundary conditions (S440), determining the number of input pixels participating in filtering and the number of boundary pixels to be filtered according to the filtering strength (S450), and filtering the boundary pixels according to the filtering strength, the number of input pixels and the number of boundary pixels (S460).

Herein, the acquiring of the encoding information (S410), the determining of the block mode pair (S420), the determining of the boundary conditions (S430), the determining of the filtering strength (S440), the determining of the filtering pixels (S450) and the filtering of the boundary pixels (S460) correspond to operations of the encoding information acquisition unit 110, the block mode determiner 120, the boundary conditions determiner 130, the filtering strength determiner 140, the filtering pixel determiner 150 and the filtering unit 160, and therefore detailed descriptions thereof will be skipped.

According to various embodiments of the present disclosure as described above, blocking artifacts are efficiently removed from stereoscopic video images in a low-performance/low-band video transmission environment. Further, by comparatively simplifying deblocking filtering of right-view images based on the properties of human vision according to the temporal spatial complexities of the images relative to deblocking filtering of left-view images, the speed of deblocking filtering is able to be increased, and subjective/objective image quality is able to be preserved equivalent to or higher than the known methods by providing a decoding apparatus with lower implementation complexity of overall deblocking filtering operation and reduced operation quantity.

Although exemplary embodiments of the present disclosure have been described for illustrative purposes, those skilled in the art will appreciate that various modifications, additions and substitutions are possible, without departing from the spirit and scope of the claimed invention. Specific terms used in this disclosure and drawings are used for illustrative purposes and not to be considered as limitations of the present disclosure. Therefore, exemplary embodiments of the present disclosure have been described for the sake of brevity and clarity. Accordingly, one of ordinary skill would understand the scope of the claimed invention is not limited by the explicitly described above embodiments but by the claims and equivalents thereof.

What is claimed is:

1. An apparatus for deblocking-filtering a secondary image from encoding information on a primary image in a stereoscopic video, the apparatus comprising:
a block mode determiner configured to determine, from a bitstream, a block mode of a current block of the primary image and a block mode of a neighboring block of the current block;
a boundary conditions determiner configured to determine a boundary condition for the current block and the neighboring block from the bitstream;
a filtering strength determiner configured to determine a filtering strength according to at least one of the block mode of the current block of the primary image, the block mode of the neighboring block and the boundary condition; and
a filtering unit configured to filter boundary pixels adjacent to a boundary between a current block of the secondary image and a neighboring block thereof according to the filtering strength.

2. The apparatus of claim 1, further comprising a filtering pixel determiner configured to determine the number of boundary pixels to be filtered according to the filtering strength.

3. The apparatus of claim 1, further comprising a filtering pixel determiner configured to determine the number of input pixels participating in filtering according to the filtering strength.

4. The apparatus of claim 1, further comprising a filtering pixel determiner configured to determine the number of input pixels participating in the filtering and the number of boundary pixels to be filtered according to the filtering strength.

5. The apparatus of claim 1, wherein a value of the filtering strength increases as a size of the current block of the primary image or the neighboring block thereof increases.

6. The apparatus of claim 1, wherein the filtering strength has a maximum value when a length of a boundary between the current block of the primary image and the neighboring block thereof is equal to a length of one side of a maximum block.

7. The apparatus of claim 1, wherein the filtering strength has a minimum value when a length of a boundary between the current block of the primary image and the neighboring block thereof is equal to a length of one side of a minimum block size.

8. A method performed by an apparatus for deblocking-filtering a secondary image from encoding information on a primary image in a stereoscopic video, the method comprising:
determining, from a bitstream, a block mode of a current block of the primary image and a block mode of a neighboring block of the current block;
determining a boundary condition for the current block and the neighboring block from the bitstream;
determining a filtering strength according to at least one of the block mode of the current block of the primary image, the block mode of the neighboring block and the boundary condition; and
filtering boundary pixels adjacent to a boundary between a current block of the secondary image and a neighboring block thereof according to the filtering strength.

9. The method of claim 8, further comprising determining the number of input pixels participating in the filtering and the number of the boundary pixels to be filtered according to the filtering strength.

10. The method of claim 8, wherein a value of the filtering strength increases as a complexity between the current block of the primary image and the neighboring block thereof increases.

11. The method of claim 7, wherein the filtering strength has a maximum value when a length of a boundary between the current block of the primary image and the neighboring block thereof is equal to a length of one side of a maximum block, and has a minimum value when the length of a boundary between the current block of the primary image and the neighboring block thereof is equal to a length of one side of a minimum block size.
